(19) United States
(12) Patent Application Publication
(10) Pub. No.: US 2004/0197501 A1
(43) Pub. Date: Oct. 7, 2004

(54) Catheter balloon formed of a polyurethane of p-phenylene diisocyanate and polycaprolactone

(76) Inventor: Srinivasan Sridharan, Morgan Hill, CA (US)

Correspondence Address: FULWIDER PATTON LEE & UTECHT, LLP, HOWARD HUGHES CENTER, 6060 CENTER DRIVE, TENTH FLOOR, LOS ANGELES, CA, 90045, US

(21) Appl. No.: 10/404,894

(22) Filed: Apr. 1, 2003

(51) Int. Cl. B65D 1/00; B29D 22/00

(52) U.S. Cl. 428/35.2

(57) ABSTRACT

A catheter balloon formed at least in part of a thermoplastic polyurethane elastomer having a p-phenylene diisocyanate hard segment and a polycaprolactone soft segment. The thermoplastic polyurethane elastomer forms a first layer of the balloon that is bonded to an elongated catheter shaft. The thermoplastic polyurethane elastomer provides improved bonding of the balloon to the elongated shaft.

### BACKGROUND OF THE INVENTION

This invention generally relates to medical devices, and particularly intracorporeal devices for therapeutic or diagnostic uses, such as balloon catheters.

In percutaneous transluminal coronary angioplasty (PTCA) procedures, a guiding catheter is advanced until the distal tip of the guiding catheter is seated in the ostium of a desired coronary artery. A guidewire is first advanced out of the distal end of the guiding catheter into the patient's coronary artery until the distal end of the guidewire crosses a lesion to be dilated. Then the dilatation catheter having an inflatable balloon on the distal portion thereof is advanced into the patient's coronary anatomy, over the previously introduced guidewire, until the balloon of the dilatation catheter is properly positioned across the lesion. Once properly positioned, the dilatation balloon is inflated with fluid one or more times to a predetermined size at relatively high pressures (e.g., greater than 8 atmospheres) so that the stenosis is compressed against the arterial wall to open up the passageway. Generally, the inflated diameter of the balloon is approximately the same diameter as the native diameter of the body lumen being dilated so as to complete the dilatation but not overexpand the artery wall. Substantial, uncontrolled expansion of the balloon against the vessel wall can cause trauma to the vessel wall. After the balloon is finally deflated, blood flow resumes through the dilated artery and the dilatation catheter can be removed therefrom.

In such angioplasty procedures, there may be restenosis of the artery, i.e. reformation of the arterial blockage, which necessitates either another angioplasty procedure, or some other method of repairing or strengthening the dilated area. To reduce the restenosis rate and to strengthen the dilated area, physicians frequently implant an intravascular prosthesis, generally called a stent, inside the artery at the site of the lesion. Stents may also be used to repair vessels having an intimal flap or dissection or to generally strengthen a weakened section of a vessel. Stents are usually delivered to a desired location within a coronary artery in a contracted condition on a balloon of a catheter which is similar in many respects to a balloon angioplasty catheter, and expanded to a larger diameter by expansion of the balloon. The balloon is deflated to remove the catheter and the stent left in place within the artery at the site of the dilated lesion. Stent covers on an inner or an outer surface of the stent have been used in, for example, the treatment of pseudo-aneurysms and perforated arteries, and to prevent prolapse of plaque. Similarly, vascular grafts comprising cylindrical tubes made from tissue or synthetic materials such as DACRON, may be implanted in vessels to strengthen or repair the vessel, or used in an anastomosis procedure to connect vessels segments together.

In the manufacture of catheters, one difficulty has been the bonding of dissimilar materials together. The fusion bonding of a dissimilar material to a substrate material can be extremely difficult if the substrate has a low surface energy. For example, lubricious materials such as HDPE and PTFE, often used to form inner tubular members of catheters to provide good guidewire movement therein, have low surface energies of 31 dynes/cm and 18 dynes/cm, respectively, that make bonding to balloons formed of a dissimilar material such as a polyamide difficult. Prior attempts to address this problem involved providing a multilayered shaft having an outer layer on the shaft configured to be bondable to the balloon. However, a decrease in shaft collapse pressure resistance may result in some cases when the outer layer has a low stiffness. While adhesives may be used in some cases to bond dissimilar materials together, they are not ideal because they can increase stiffness of the component at the bond and some materials do not bond well to adhesives commonly used in medical devices.

A catheter balloon formed of expanded polytetrafluoroethylene (ePTFE) has been suggested. ePTFE is PTFE which has been expanded to form porous ePTFE which typically has a node and fibril microstructure comprising nodes interconnected by fibrils. However, ePTFE has proven difficult to bond to balloon liner materials and/or to catheter shafts. One difficulty has been bonding ePTFE absent the use of adhesives and/or some pretreatment causing decomposition of the fibril structure.

It would be a significant advance to provide a catheter balloon, or other medical device component, with improved performance and bondability.

### SUMMARY OF THE INVENTION

This invention is directed to a catheter balloon formed at least in part of a thermoplastic polyurethane elastomer having a p-phenylene diisocyanate (PPDI) hard segment and a polycaprolactone soft segment. One aspect of the invention is directed to a balloon catheter having a balloon formed at least in part of the thermoplastic polyurethane elastomer which is bonded to an elongated shaft, and having an improved strong bond between the balloon and the shaft.

Polyurethane elastomers are copolymers that have a polyol soft segment and a polyisocyanate hard segment (i.e., a segmented copolymer having one or more soft blocks or segments comprising a polyol and one or more hard blocks or segments comprising a polyisocyanate). In particular, the thermoplastic polyurethane elastomer for forming a catheter balloon of the present invention has a soft segment formed of a polycaprolactone polyol and a hard segment formed of a polyisocyanate that is based on PPDI. Such a polyurethane is also generally described as a PPDI-based polyurethane having a polycaprolactone backbone.

The PPDI-based polyurethane for forming catheter balloons of the present invention preferably has high strength, low modulus, high elongation, and low tensile set, to provide improved balloon performance. Specifically, the PPDI-based polyurethane has a low tensile set of less than about 30% which facilitates deflation of the balloon to a low profile deflated configuration. Further, in a presently preferred embodiment, the PPDI-based polyurethane has a high elongation of at least about 300%.

A balloon catheter of the invention generally comprises an elongated shaft and a balloon bonded to the elongated shaft. The balloon is formed at least in part of the PPDI-based polyurethane, and, preferably, the PPDI-based polyurethane forms a first layer of the balloon that extends from a proximal skirt section to a distal skirt section of the balloon. The first layer is preferably fusion bonded, but may also be adhesive bonded, to the shaft at the proximal skirt section and the distal skirt section. The shaft may be formed from a variety of polymers including, but not limited to, a polyamide, a poly (ether block amide) copolymer, a polyurethane, a polyethylene, a polyester and a polyimide, each of which bonds readily to the polyurethane first layer.

The catheter shaft typically comprises an outer tubular member defining a inflation lumen, and an inner tubular member defining a guidewire lumen extending at least within a distal shaft section, with the balloon proximal skirt section bonded to a distal portion of the outer tubular member and the balloon distal skirt section bonded to a distal portion of the inner tubular member. However, a variety of suitable catheter configurations can be used as are conventionally known, including dual lumen designs. The balloon catheter can be an over-the-wire type catheter with a guidewire lumen extending from the proximal to the distal end of the catheter, or alternatively a rapid exchange type catheter with a distal guidewire port in a distal end of the catheter, a proximal guidewire port in a distal shaft section distal of the proximal end of the shaft and typically spaced a substantial distance from the proximal end of the catheter, and a short guidewire lumen extending between the proximal and distal guidewire ports in the distal section of the catheter. A balloon catheter of the invention can be configured for use in a variety of applications including coronary and peripheral dilatation, stent delivery, drug delivery, and the like.

In a presently preferred embodiment, the PPDI-based polyurethane first layer is bonded to a second layer. The second layer preferably comprises expanded polytetrafluoroethylene (ePTFE), although a variety of suitable materials may be used including a porous polymeric material which in one embodiment is selected from the group consisting of ePTFE, an ultra high molecular weight polyolefin such as ultra high molecular weight polyethylene, porous polyethylene, porous polypropylene, and porous polyurethane. In one embodiment, the porous material has a node and fibril microstructure. The node and fibril microstructure, when present, is produced in the material using conventional methods. ePTFE and ultra high molecular weight polyethylene (also referred to as “expanded ultra high molecular weight polyethylene”) typically have a node and fibril microstructure, and are not melt extrudable. However, a variety of suitable polymeric materials can be used in the method of the invention including conventional catheter balloon materials which are melt extrudable. Preferably, ePTFE is formed into a balloon layer by bonding wrapped layers of the polymeric material together to form a tubular member, and not by conventional balloon blow molding. Although discussed primarily in terms of the embodiment in which the second layer of the balloon comprises ePTFE, it should be understood that a variety of suitable polymers may be used for the second layer.

The PPDI-based polyurethane should have a low inelastic stress response or tensile set (i.e., the extension remaining after a specimen has been stretched and allowed to retract in a specified manner, expressed as a percentage of original size; see ASTM D412). Consequently, the balloon retracts to a low profile deflated configuration, despite the inelasticity of the ePTFE layer.

A suitable thermoplastic polyurethane elastomer having a p-phenylene diisocyanate hard segment and a polycaprolactone soft segment for forming the catheter balloon is HYLENE TPE, available from DuPont. HYLENE TPE has a high elongation of about 500% to 600%, a sufficiently low initial modulus of about 1600 psi to 1900 psi at 100% elongation to minimally affect the compliance of the ePTFE layer, and a high tensile strength of about 6000 psi to 8500 psi to retract the ePTFE layer after radial expansion of the balloon. HYLENE TPE further resists physical deformation upon application of stress, returning to close to its initial dimensions when the stress is removed. For example, HYLENE TPE has a low compression set (i.e., the deformation remaining after a specimen has been compressed and allowed to recover in a specified manner, expressed as a percentage of original size; see ASTM D395B) of about 16.7% at 70° C. after 70 hours.

The PPDI-based polyurethane layer is bonded to the ePTFE layer preferably by fusion bonding, although adhesive bonding may alternatively be used. In some embodiments, the surface of the ePTFE layer is treated or chemically modified to improve its bondability to the PPDI-based polyurethane layer.

In one embodiment, the balloon second layer has at least a section with a gas plasma-etched or chemical solution-etched surface. The etched surface is the result of a chemical reaction between the porous polymeric material forming the second layer and the etching compound. In one embodiment, the second layer is chemical solution-etched, and is preferably chemical solution-etched using a sodium naphthalene solution comprising sodium naphthalene in ether. The chemical solution-etching produces a carbonaceous surface, resulting from the removal of fluorine atoms, and introduces hydroxyl, carbonyl, and/or carboxyl functionalities on and beneath the surface of the porous polymeric material (e.g., ePTFE). Alternative solutions can also be used including a sodium-ammonia complex in liquid ammonia, and a sodium naphthalene complex in tetrahydrofuran, and alternative processes can be used including gas plasma-etching. The terminology “etch” used herein in relation to the embodiment involving a plasma gas treatment should be understood to refer generally to the modification of the porous polymeric material which results from the gas-plasma treatment. In one embodiment, the gas plasma etched/treated surface is formed using an ammonia plasma (e.g., treatment with ammonia anions by reaction in an ammonia gas filled plasma chamber). Alternative gases may be used in the gas plasma etching including argon, helium, hydrogen, oxygen, and air, in addition to or instead of the ammonia gas. The ammonia gas plasma etching provides an amine functionality on and beneath the surface of the second layer (e.g., the ePTFE layer) of the balloon, for improved bondability.

In another embodiment, the ePTFE layer is coated or impregnated with a bondable material to improve the bonding of the ePTFE layer to the PPDI-based polyurethane layer. In one embodiment, the bondable material on the ePTFE second layer is a plasma polymerized functionality bonded to at least a section of the ePTFE layer. Alternatively, the bondable material is a polymer impregnated in the ePTFE.

In plasma polymerization, free-radical organic species, such as fragmented acrylic acid, in the plasma will couple with the surface of the ePTFE substrate, resulting in a crosslinked thin film which is covalently bonded to the ePTFE. The plasma polymerized film may comprise a variety of suitable functionalities including carboxylate, amine, and sulfonate groups, which are polymerized on at least a surface of the porous polymeric layer. In one embodiment, the plasma polymerized carboxylate film comprises an acrylate or acrylate-like polymer layer deposited onto the ePTFE by exposing the ePTFE film to a plasma, which in one embodiment is an acrylic acid plasma. One of skill in the art will recognize that some fragmentation of the acrylate typically occurs as the result of plasma polymerization, producing an acrylate-like polymer layer of fragmented acrylate. In one embodiment, the surface is carboxylate-rich from an acrylic acid plasma. However, a variety of suitable plasma polymerized films may be used as the bondable material on the ePTFE layer, including plasma polymerized allyl amine providing an amine-rich film. The plasma polymerized film is typically crosslinked to varying degrees depending on the nature of the reactive species in the plasma which form the film and the radiofrequency (RF) intensity used in the plasma polymerization process.

In another embodiment, the balloon includes a layer of porous polymeric material, such as ePTFE, impregnated with the PPDI-based polyurethane. In one embodiment, ePTFE is impregnated with a solution of the PPDI-based polyurethane so that the PPDI-based polyurethane impregnates the pores of the ePTFE. Typically, an inner surface of the ePTFE tube is exposed to the PPDI-based polyurethane solution in the inner lumen of the ePTFE tube to impregnate the ePTFE tube, and the PPDI-based polyurethane also coats the inner surface of the ePTFE tube. The balloon in this embodiment may optionally be a multilayered balloon having a first layer formed of the PPDI-based polyurethane and a second layer formed of the impregnated ePTFE. The first layer may be adhesively or fusion bonded to the impregnated ePTFE layer, and is preferably fusion bonded.

In one embodiment of a method of making a balloon for a catheter, which embodies features of the invention, a first layer formed of the PPDI-based polyurethane is positioned against a second layer, which may be a porous polymeric material such as ePTFE etched or otherwise treated with a bondable material, and the layers are heated to fusion bond together.

In an alternative method of making a balloon for a catheter, which embodies features of the invention, a layer formed of a porous polymeric material such as ePTFE is exposed to an aqueous or organic solution of the PPDI-based polyurethane, so that the polyurethane impregnates the ePTFE by completely or partially filling the pores of the ePTFE.

In one embodiment of a method of making a balloon catheter, which embodies features of the invention, the PPDI-based polyurethane layer of the balloon is fusion bonded to the polymer catheter shaft. Preferably, the PPDI-based polyurethane first layer is fusion bonded to the catheter shaft material with a bond seal strength of at least about 300 psi.

The balloon of the invention can be used with a variety of suitable balloon catheters including coronary angioplasty catheters, peripheral dilatation catheters, stent delivery catheters, drug delivery catheters, and the like. Balloon catheters of the invention catheter generally comprise an elongated shaft with at least one lumen and balloon on a distal shaft section with an interior in fluid communication with the at least one lumen. The PPDI-based polyurethane layer may be formed by conventional methods such as melt extruding the PPDI-based polyurethane into a tubular shape or, alternatively, dip coating. The ePTFE or other porous polymeric tubular layer can also be formed using conventional methods, generally including wrapping a sheet of ePTFE or other polymer around a mandrel and heat fusing the wrapped material together to form a tube. The ePTFE generally is porous, and typically has a node and fibril microstructure. Although discussed primarily in terms of a porous polymeric layer formed of ePTFE, it should be understood that the porous layer may comprise other materials including polymers having a porous structure, polyethylene and fluoropolymers in general, and polymers having a node and fibril microstructure including ultrahigh molecular weight polyolefin such as ultrahigh molecular weight polyethylene, and polypropylene, where conventional fusion bonding fails and surface modification is required. It should be understood that a balloon having a layer formed of a porous material such as ePTFE or ultrahigh molecular weight polyethylene may have the pores of the porous material partially or completely filled by another polymeric material.

The balloon of the invention has excellent performance characteristics such as a low profile deflated configuration, high strength, flexibility and conformability, and improved manufacturability. Additionally, the PPDI-based polyurethane balloon layer has an improved bond to an adjacent catheter component, such as a catheter shaft, and in particular a catheter shaft formed of nylon or PEBAX. The PPDI-based polyurethane readily fusion bonds to nylon and PEBAX through hydrogen bonding without the use of adhesives or a bonding promoter. These and other advantages of the invention will become more apparent from the following detailed description when taken in conjunction with the accompanying exemplary drawings.

### BRIEF DESCRIPTION OF THE DRAWINGS

FIG. 1 is an elevational view, partially in section, of a balloon catheter for delivering a stent, that embodies features of the invention, having a balloon with a first layer formed of a thermoplastic polyurethane elastomer having a p-phenylene diisocyanate (PPDI) hard segment and a polycaprolactone soft segment, and a second layer formed of a porous polymeric material bonded to the first layer.

FIG. 2 is a transverse cross-section of the catheter shown in FIG. 1 taken at line 2-2.

FIG. 3 is a transverse cross-section of the catheter shown in FIG. 1 taken at line 3-3.

FIG. 4 is a longitudinal cross section of a distal end of an alternative embodiment of a balloon catheter that embodies features of the invention, having a balloon with a single layer impregnated with the thermoplastic polyurethane elastomer.

FIG. 5 is a transverse cross-section of the catheter shown in FIG. 4 taken at line 5-5.

FIG. 6 is a longitudinal cross section of a distal end of an alternative embodiment of a balloon catheter that embodies features of the invention, having a balloon with a first layer formed of the thermoplastic polyurethane elastomer and a second layer impregnated with the thermoplastic polyurethane elastomer bonded thereto.

FIG. 7 is a transverse cross-section of the catheter shown in FIG. 6 taken at line 7-7.

### DETAILED DESCRIPTION OF THE PREFERRED EMBODIMENTS

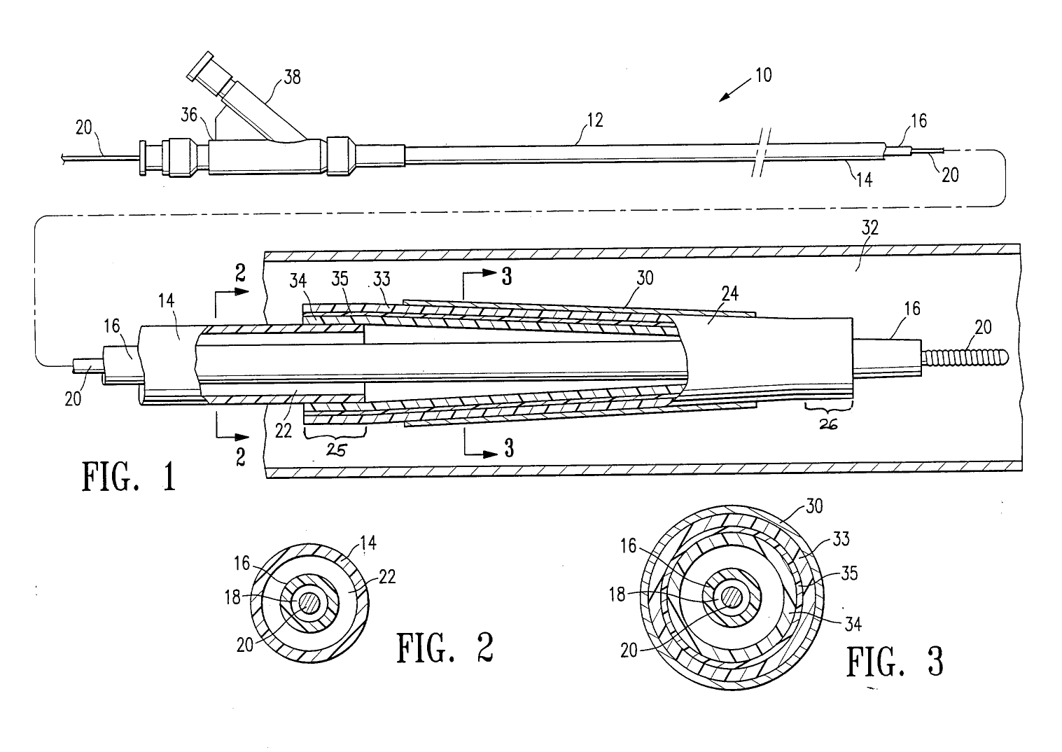

FIGS. 1-3 illustrate an over-the-wire type stent delivery balloon catheter 10 embodying features of the invention. Catheter 10 generally comprises an elongated catheter shaft 12 having an outer tubular member 14 and an inner tubular member 16. As best illustrated in FIGS. 2 and 3, showing transverse cross sections of the catheter of FIG. 1, taken along lines 2-2 and 3-3, respectively, inner tubular member 16 defines a guidewire lumen 18 configured to slidingly receive a guidewire 20, and the coaxial relationship between outer tubular member 14 and inner tubular member 16 defines annular inflation lumen 22. An inflatable balloon 24 disposed on a distal section of an elongated catheter shaft 12 has a proximal skirt section 25 sealingly secured to the distal end of outer tubular member 14 and a distal skirt section 26 sealingly secured to the distal end of inner tubular member 16, so that its interior is in fluid communication with inflation lumen 22. An adapter 36 at the proximal end of catheter shaft 12 is configured to direct inflation fluid through arm 38 into inflation lumen 22 and to provide access to guidewire lumen 18. Balloon 24 has an inflatable working length located between tapered sections of the balloon. An expandable stent 30 is mounted on balloon working length. FIG. 1 illustrates the balloon 24 prior to complete inflation of the balloon. The distal end of the catheter may be advanced to a desired region of a patient's body lumen 32 in a conventional manner, and balloon 24 inflated to expand stent 30, seating the stent in the body lumen 32.

In the embodiment illustrated in FIG. 1, the balloon 24 comprises a first layer 34 formed of a thermoplastic polyurethane elastomer having a p-phenylene diisocyanate hard segment and a polycaprolactone soft segment, and a second layer 33 formed of a porous polymeric material. In a preferred embodiment, layer 34 is an inner layer relative to layer 33, although in other embodiments it may be an outer layer relative to layer 33. Layer 34 limits or prevents leakage of inflation fluid through the porous layer 33 to allow for inflation of the balloon 24, and is highly elastic to facilitate deflation of the balloon 24 to a low profile deflated configuration. In particular, the PPDI-based polyurethane preferably has a low tensile set of less than about 30% which facilitates deflation of the balloon to a low profile deflated configuration and a high elongation of at least about 300%. The relative amounts of the soft segment and the hard segment in the PPDI-based polyurethane of layer 34 may be varied depending on the desired balloon characteristics for a given application. The PPDI-based polyurethane may also include various additives, including chain extenders or curatives, catalysts, fillers, colorants, dyes and stabilizers. In particular, the hard segment further includes a chain extender, such as 1,4-butanediol or other suitable amine or glycol, to which the isocyanate forms urethane or urea linkages for crosslinking with the polyol.

A suitable thermoplastic polyurethane elastomer having a p-phenylene diisocyanate hard segment and a polycaprolactone soft segment is HYLENE TPE available from DuPont. HYLENE TPE has an elongation of about 500% to 600%, a initial modulus of about 1600 psi to 1900 psi at 100% elongation, and a high tensile strength of about 6000 psi to 8500 psi, and a low compression set of about 16.7% at 70° C. after 70 hours.

In one embodiment, the first layer 34 is formed entirely from the PPDI-based polyurethane, but in alternative embodiments, the first layer may be partly formed from the PPDI-based polyurethane. For example, the first layer 34 may be formed from HYLENE TPE blended with additional polymers, such as PURSIL or other polyurethanes. Preferably, the PPDI-based polyurethane is present in a sufficient amount to avoid disadvantageously affecting elongation and tensile set.

Preferably, balloon 24 has a length about 0.5 cm to about 4 cm and typically about 2 cm, and an inflated working diameter of about 1 to about 8 mm, and in a preferred embodiment, an uninflated diameter of not greater than about 1.3 mm. The thickness of the PPDI-based polyurethane first layer 34 may be about 0.001 inch to about 0.006 inch, preferably about 0.002 inch to about 0.004 inch, and the thickness of the second layer 33 may be about 0.001 inch to about 0.006 inch, preferably about 0.002 inch to about 0.004 inch.

The porous polymeric material of layer 33 may be formed from a variety of suitable materials, including, but not limited to, ePTFE, an ultra high molecular weight polyolefin such as ultra high molecular weight polyethylene, porous polyethylene, porous polypropylene, and porous polyurethane. In a presently preferred embodiment, the porous polymeric material has a node and fibril microstructure, such as ePTFE.

In the embodiment of FIG. 1, the layer 34 is a separate layer which in one embodiment neither fills the pores nor disturbs the node and fibril structure of the porous second layer 33. In an alternative embodiment, the PPDI-based polyurethane at least partially fills the pores of porous second layer. Typically, the porous polymeric material comprises a film of stretched material which is formed into the tubular member layer 33 by wrapping the material around a mandrel to form a tube and then heating the wrapped material to fuse the wrapped material together.

In the embodiment illustrated in FIG. 1, the porous layer 33 of the balloon is treated to provide a chemically modified surface 35 of the layer 33 that improves bondability of the porous polymeric material, such as ePTFE. The modified surface 35, as discussed below, may be an etched surface, or a plasma polymerized surface that forms a plasma polymerized film.

In one embodiment, the second ePTFE layer 33 of the balloon 24 has a modified surface 35 which is gas plasma-etched or chemical solution-etched along at least a section of the length of the ePTFE layer 33. In one embodiment, the etched section of the inner surface of the ePTFE layer 33 extends along the entire length of the inner surface of the ePTFE layer 33, to provide a secure bond to the first layer 34.

The etching of the etched inner surface 35, which is exaggerated in FIG. 1 for ease of illustration, preferably extends from the inner surface of the outer layer to a depth of about 0.04 to about 1.2% of a wall thickness of the ePTFE layer 33 (prior to inflation of the balloon). Specifically, in one embodiment, the ePTFE layer 33 has a wall thickness of about 50 to about 150 microns, and the etching of the etched inner surface 35 of the ePTFE layer 33 extends from the inner surface of the ePTFE layer 33 to a depth of about 500 to about 600 nanometers.

In a presently preferred embodiment, the etched surface 35 of the ePTFE second layer 33 is prepared using a sodium naphthalene etching solution. The ePTFE layer 33 is etched by exposing the tube which forms the ePTFE layer 33 to a solution of sodium naphthalene in ether, as for example by dipping the tube in a container of the solution. Sections of the tube may be masked to prevent etching of the sections before dipping the tube in the etching solution. For example, a tightly fitting mandrel may be used in the inner lumen of the tube to mask sections of the inner surface of the tube. The duration of the tube in the etching solution is carefully controlled to limit the depth of the etching, although the etching solution reaction is typically a self-limiting reaction. After removal from the etching solution, the tube is typically dipped or otherwise rinsed in a solution such as isopropyl alcohol to quench/deactivate any remaining etching solution thereon. The quenching solution is then rinsed using warm water and the resulting etched tube is dried.

In an alternative embodiment, the etched surface 35 of the ePTFE layer 33 is prepared using ammonia gas plasma etching. The ePTFE layer 33 is etched by placing a sheathed ePTFE tube in a plasma chamber. For example, in one embodiment, the plasma chamber has ammonia gas at a pressure of about 80 to about 90 mtorr. In another embodiment, in addition to the reactive species formed by the ammonia, hydrogen gas (H₂) included in the chamber with the ammonia gas forms reactive species.

In another embodiment, the modified surface 35 of the second layer 33 is a chemically modified surface that provides a plasma polymerized film which facilitates bonding layer 33 to layer 34. At least a section of the ePTFE layer 33, and preferably the entire length of at least an inner surface of ePTFE layer 33, has the plasma polymerized film. However, in alternative embodiments, less than the entire length may be chemically modified, by masking a part of the ePTFE substrate using methods conventionally known in the field. The thickness of the plasma polymerized film 35, which is exaggerated in FIG. 1 for ease of illustration, is about 10 nm to about 150 nm thick, preferably about 10 nm to about 50 nm thick. In one embodiment, the balloon is chemically modified to create a carboxylate-rich surface. However, a variety of suitable functionalities can be plasma polymerized on the surface of the balloon including amine, and sulfate functionalities. In one embodiment, the plasma polymerized carboxylate film comprises an acrylate or acrylate-like polymer layer deposited onto the ePTFE by exposing the ePTFE film to a plasma, which in one embodiment is an acrylic acid plasma. While discussed primarily in terms of applying a carboxylate film by plasma polymerization of acrylic acid on ePTFE, it should be understood that a variety of functionalities may be used.

The PPDI-based polyurethane first layer 34 is readily fusion bondable to etched or plasma polymerized treated ePTFE layer 33 having a modified surface 35 thereon. Although the PPDI-based polyurethane is readily bondable to the surface modified ePTFE or other porous material, an additional agent which further facilitates bonding to the ePTFE layer 33 may be used in one embodiment. For example, the first layer 34 may include a bonding promoter (not shown) mixed with the PPDI-based polyurethane, which covalently bonds to the PPDI-based polyurethane and bonds to the surface modified ePTFE of layer 33. In one embodiment, the bonding promoter vulcanizes the PPDI-based polyurethane and hydrogen-bonds to the plasma polymerized functionality on the ePTFE layer 33, allowing layer 33 to fusion bond to layer 34. It should be understood, however, that in addition to a bonding promoter that vulcanizes the PPDI-based polyurethane, a variety of suitable bonding promoters may be used which covalently bond to unsaturation of the PPDI-based polyurethane.

In an alternative embodiment (not shown), a balloon having first layer 34 and ePTFE second layer 33 includes an adhesive between ePTFE layer 33 and layer 34 to adhesively bond layers 33 and 34 together. A variety of suitable adhesives commonly used in the medical device field may be used. In one embodiment, the adhesive bonds layer 33 to layer 34 without the use of a modified surface 35 on layer 33. However, in one embodiment, an etched or plasma polymerized surface 35 is provided on layer 33 to facilitate bonding the adhesive to layer 33.

The first layer 34 is fusion bondable to conventional polymeric materials such as polyamides and polyurethanes which may be used to form catheter shaft 12. The PPDI-based polyurethane of the first layer 34 is typically melt extruded into a tubular shape to form layer 34, although the layer 34 may alternatively be formed by processes such as dip coating or solvent casting. In one embodiment, the PPDI-based polyurethane first layer 34 is fusion bonded to the catheter shaft material with a bond seal strength of at least about 300 psi.

In the embodiment illustrated in FIG. 1, balloon 24 is preferably secured to the shaft 12 by fusion bonding the outer surface of the outer tubular member 14 and inner tubular member 16. The use of the PPDI-based polyurethane layer 34 facilitates fusion bonding of the balloon to the catheter shaft because the PPDI-based polyurethane is compatible with conventional catheter shaft materials such as polyurethanes and polyamides. Using conventional heat/laser bonding methods, the balloon proximal skirt is placed over the distal section of the outer tubular member 14, and the balloon distal skirt is placed over the distal section of the inner tubular member 16, and heat applied to the balloon skirt sections to melt or soften the polymeric material. A heat shrink sleeve may also be used during fusion bonding which shrinks to provide pressure at the bond site. Although discussed primarily in terms of fusion bonding the balloon 24 to the shaft 12, in an alternative embodiment, the two components are adhesively bonded together. A variety of suitable adhesives commonly used in the medical device field may be used, and preferably adhesives such as acrylates, epoxies, and urethanes, and the adhesive is applied as is conventionally known by spraying, dipping or otherwise coating a section of the shaft to be bonded.

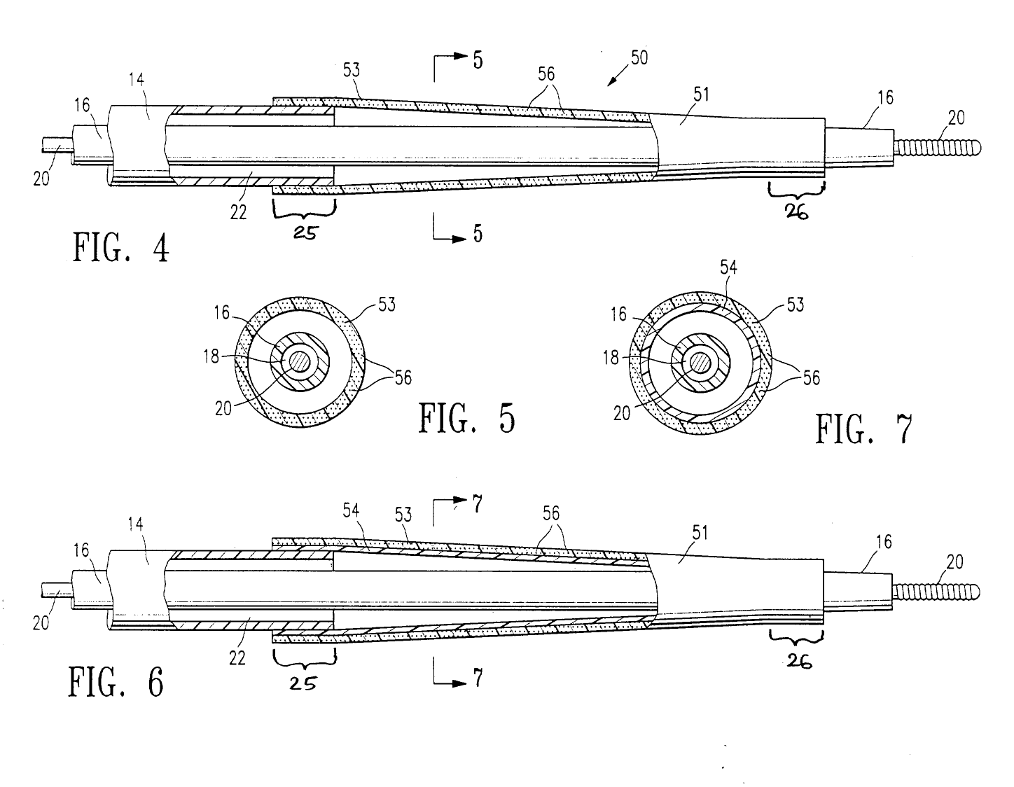

FIG. 4 illustrates the distal end of an alternative balloon catheter 50 which embodies features of the invention, similar to balloon catheter 10 of FIG. 1, but having a balloon 51 bonded to outer tubular member 14 and inner tubular member 16. FIG. 5 illustrates a transverse cross section of the balloon catheter of FIG. 4, taken along line 5-5. Balloon 51 comprises a porous polymeric material, shown as layer 33, preferably ePTFE, impregnated with a thermoplastic polyurethane elastomer having a p-phenylene diisocyanate hard segment and a polycaprolactone soft segment. For example, a solution may be formed by dissolving the PPDI-based polyurethane in an organic solvent such as tetrahydrofuran. The solution is coated onto the inside of an ePTFE or other porous polymeric tube using a variety of suitable methods. In one embodiment, the solution is injected into the lumen of the ePTFE tube using a syringe or other device to deliver the solution, preferably after one end of the ePTFE tube is reversibly closed for example by being tied or otherwise blocked. Excess solution is removed from the ePTFE tube lumen, leaving solution in the porous structure of the ePTFE and on the inner surface of the ePTFE tube. In an alternative embodiment, the ePTFE tube is inserted inside a container, such as a glass mold, with the solution of PPDI-based polyurethane in the container, and a vacuum is applied to the lumen of the ePTFE tube to draw the PPDI-based polyurethane solution up into the ePTFE tube lumen. The vacuum is turned off and the solution allowed to drain off from inside the ePTFE tube leaving the solution as in the above method. The solution may include surfactants, such as fluorocarbon surfactants including FC 430 and FC 129 available from 3M, or ZONYL available from Zeneca, to form a compatible interface between the ePTFE node and fibril structure and the PPDI-based polyurethane. Additionally, the inner surface of the ePTFE tube can be plasma etched, using for example an argon plasma, to improve surface wetability. The thus coated ePTFE tube is exposed to elevated temperature or blown air (elevated or ambient temperature), to evaporate the solvent. The resulting ePTFE tube has PPDI-based polyurethane 56 impregnated in the pores of the ePTFE and thus mechanically connected to the ePTFE tube. Although not illustrated, some of the PPDI-based polyurethane 56 typically coats an inner surface of the ePTFE tube, so that it is preferably at least in part on an inner surface of the ePTFE layer 53. The resulting impregnated ePTFE layer 53 is completely or partially impregnated with the PPDI-based polyurethane 56, and in a presently preferred embodiment is partially impregnated with the PPDI-based polyurethane.

FIG. 6 illustrates another embodiment, having balloon 51 comprising a first layer 54 formed of the PPDI-based polyurethane bonded to a second layer comprising the impregnated ePTFE layer 53. FIG. 7 illustrates a transverse cross section of the balloon catheter of FIG. 6, taken along line 7-7. The first layer 54 is similar to layer 34 of the embodiment of FIG. 1. Preferably, the first layer 54 is fusion bonded to the ePTFE layer 53 impregnated with the PPDI-based polyurethane, using a method such as the method discussed above in relation to the embodiment of FIG. 1.

It is to be understood that the catheter balloon of the present invention may be a single layer balloon formed at least in part of the PPDI-based polyurethane or may alternatively be a multilayered balloon having two or more layers, at least one of which is formed at least in part of the PPDI-based polyurethane. In embodiments in which the balloon has a single layer formed of the PPDI-based polyurethane, the balloon may be similar to the balloon 51 that has a single layer 53 (FIG. 4), but wherein the single layer 53 is formed of the PPDI-based polyurethane, rather than ePTFE impregnated with the polyurethane.

To the extent not previously discussed herein, the various catheter components may be formed and joined by conventional materials and methods. For example, inner tubular member 16 and outer tubular member 14 can be formed by conventional techniques, such as by extruding and necking materials found useful in intravascular catheters such a polyethylene, polyvinyl chloride, polyesters, polyamides, polyimides, polyurethanes, and composite materials.

The dimensions of catheter 10 are determined largely by the size of the balloon and guidewires to be employed, catheter type, and the size of the artery or other body lumen through which the catheter must pass or the size of the stent being delivered. Typically, the outer tubular member 14 has an outer diameter of about 0.025 to about 0.04 inch (0.064 to 0.10 cm), usually about 0.037 inch (0.094 cm), the wall thickness of the outer tubular member 14 can vary from about 0.002 to about 0.008 inch (0.0051 to 0.02 cm), typically about 0.002 to 0.005 inch (0.005 to 0.013 cm). The inner tubular member 16 typically has an inner diameter of about 0.01 to about 0.018 inch (0.025 to 0.046 cm), usually about 0.016 inch (0.04 cm), and wall thickness of 0.002 to 0.008 inch (0.005 to 0.02 cm). The overall length of the catheter 10 may range from about 100 to about 150 cm, and is typically about 135 cm.

While the present invention is described herein in terms of certain preferred embodiments, various modifications and improvements may be made to the invention without departing from the scope thereof. For example, in the embodiment illustrated in FIG. 1, the outer and inner tubular members 14, 16 are each formed of a single-layered, uniform polymeric member. However, it should be understood that in alternative embodiments, one or both of the outer and inner tubular members 14, 16 may be a multilayered or blended polymeric member. Although the shaft is illustrated as having an inner and outer tubular member, a variety of suitable shaft configurations may be used including a dual lumen extruded shaft having a side-by-side lumens extruded therein. Further, in the embodiment illustrated in FIG. 1, the catheter is over-the-wire stent delivery catheter. However, one of skill in the art will readily recognize that other types of intravascular catheters may be used, such as rapid exchange dilatation catheters having a distal guidewire port and a proximal guidewire port and a short guidewire lumen extending between the proximal and distal guidewire ports in a distal section of the catheter. Additionally, although discussed in terms of a balloon for a catheter, a variety of medical devices or components thereof may be made according the invention, including a soft distal tip for a catheter shaft, an expandable cover for a stent, and a vascular graft. Although individual features of one embodiment of the invention may be discussed herein or shown in the drawings of one embodiment and not in other embodiments, it should be apparent that individual features of one embodiment may be combined with one or more features of another embodiment or features from a plurality of embodiments.

What is claimed:

1. A balloon for a catheter, the balloon being formed at least in part of a thermoplastic polyurethane elastomer, the thermoplastic polyurethane elastomer comprising:
a) a p-phenylene dilsocyanate hard segment; and
b) a polycaprolactone soft segment.

2. The balloon of claim 1 wherein the thermoplastic polyurethane elastomer forms a first layer of the balloon.

3. The balloon of claim 2 further comprising a second layer formed of a porous polymeric material bonded to the first layer.

4. The balloon of claim 3 wherein the porous polymeric material forming the second layer is selected from the group consisting of expanded polytetrafluoroethylene, ultra high molecular weight polyolefin, ultra high molecular weight polyethylene, porous polyethylene, porous polypropylene and porous polyurethane.

5. A balloon for a catheter, comprising:
a) a first layer formed of a thermoplastic polyurethane elastomer having a p-phenylene diisocyanate hard segment and a polycaprolactone soft segment; and
b) a second layer bonded to the first layer and formed of a porous polymeric material.

6. The balloon of claim 5 wherein the porous polymeric material forming the second layer is selected from the group consisting of expanded polytetrafluoroethylene, ultra high molecular weight polyolefin, ultra high molecular weight polyethylene, porous polyethylene, porous polypropylene and porous polyurethane.

7. The balloon of claim 5 wherein the porous polymeric material forming the second layer is expanded polytetrafluoroethylene.

8. The balloon of claim 5 wherein the second layer has a chemically modified surface for bonding to the first layer.

9. The balloon of claim 8 wherein the chemically modified surface is a gas plasma or chemical solution etched surface.

10. The balloon of claim 8 wherein the chemically modified surface is a plasma polymerized surface.

11. A balloon for a catheter, comprising:
a) a porous polymeric material impregnated with a thermoplastic polyurethane elastomer having a p-phenylene diisocyanate hard segment and a polycaprolactone soft segment.

12. The balloon of claim 11 wherein the porous polymeric material is selected from the group consisting of expanded polytetrafluoroethylene, ultra high molecular weight polyolefin, ultra high molecular weight polyethylene, porous polyethylene, porous polypropylene and porous polyurethane.

13. The balloon of claim 11 wherein the porous polymeric material is expanded polytetrafluoroethylene.

14. The balloon of claim 11 wherein the balloon is a multilayered balloon with a first layer formed of a thermoplastic polyurethane elastomer having a p-phenylene diisocyanate hard segment and a polycaprolactone soft segment, and a second layer formed of the impregnated porous polymeric material bonded to the first layer.

15. A balloon catheter, comprising:
a) an elongated shaft formed of a polymer; and
b) a balloon bonded to the elongated shaft, the balloon being formed at least in part of a thermoplastic polyurethane elastomer having a p-phenylene diisocyanate hard segment and a polycaprolactone soft segment.

16. The balloon catheter of claim 15 wherein the polymer forming the elongated shaft is selected from the group consisting of a polyamide, a poly (ether block amide) copolymer, a polyurethane, a polyethylene, a polyester and a polyimide.

17. The balloon catheter of claim 15 wherein the polymer forming the elongated shaft is selected from the group consisting of a polyamide and a poly (ether block amide) copolymer.

18. The balloon catheter of claim 15 wherein the balloon further has a proximal and a distal skirt section, and the thermoplastic polyurethane elastomer forms a first layer that extends from the proximal skirt section to the distal skirt section.

19. The balloon catheter of claim 18 wherein the first layer of the balloon is bonded to the elongated shaft at the distal and proximal skirt sections.

20. The balloon catheter of claim 19 wherein the balloon is fusion bonded to the elongated shaft.

21. The balloon catheter of claim 20 wherein the balloon is fusion bonded to the elongated shaft with a bond seal strength of at least 300 psi.
